(19) United States
(12) Patent Application Publication
(10) Pub. No.: US 2009/0180406 A1
(43) Pub. Date: Jul. 16, 2009

(54) Method for reducing interferences

(76) Inventors: Volker Breuer, Bötzow (DE); Michael Färber, Wolfratshausen (DE)

Correspondence Address: STAAS & HALSEY LLP, SUITE 700, 1201 NEW YORK AVENUE, N.W., WASHINGTON, DC, 20005, US

(21) Appl. No.: 12/227,771

(22) PCT Filed: Apr. 27, 2007
(86) PCT No.: PCT/EP2007/054133

§ 371 Date: Nov. 26, 2008

(30) Foreign Application Priority Data
May 26, 2006 (EP) 06010858.6

(51) Int. Cl. H04J 3/00; H04J 1/00

(52) U.S. Cl. 370/280; 370/281

(57) ABSTRACT

Interference is reduced between two radio communication systems. A first radio communication system uses a first and a second frequency ranges which are separated by a duplex gap. A second radio communication system uses a third radio frequency range which forms part of the duplex gap. The first and second radio communication systems exchange information in order to establish an a priori knowledge about a connection on the network side. The a priori knowledge includes the radio transmission resources of the first frequency range provided on the radio communication system side and of the second frequency range and the radio transmission resources of the third frequency range (FB3) desired for call setup and completion. Radio transmission resources are selected depending on the a priori knowledge at the second radio communication system in order to reduce interferences between the first and second radio communication systems.

### CROSS-REFERENCE TO RELATED APPLICATIONS

This application is based on and hereby claims priority to European Application No. EP 06010858, filed May 26, 2006, and PCT Application No. PCT/EP2007/054133, filed Apr. 27, 2007, the contents of which are incorporated herein by reference.

### BACKGROUND

1. Field

The invention relates to a method for reducing interference between two radio communication systems which use different duplex technologies for radio transmission, in which a first radio communication system and a second radio communication system access radio transmission resources of a common frequency band for carrying out the radio transmission.

2. Description of the Related Art

Due to rising numbers of subscribers and the increasing demand for services, there are considerations to operate radio transmission methods which access radio transmission resources of a common frequency band in parallel next to one another.

In this context, disturbances or interference occurring due to the parallel operation should be limited to a minimum, on the one hand, whilst, on the other hand, an available stock of frequencies or available radio transmission resources, respectively, should be optimally utilized.

For example, it is possible to use a duplex radio transmission method as the first radio transmission method which accesses radio transmission resources of two frequency ranges, the two frequency ranges being separated from one another by a so-called “duplex gap” (which is sometimes also called simply “duplex band”).

The two frequency ranges which are used by the first radio transmission method, and the duplex gap, are allocated to a common frequency band.

For example, the frequency division duplex “FDD” or the time division duplex “TDD” radio transmission method are known as typical duplex radio transmission methods.

In a duplex radio transmission method, the possibility exists of using a second radio transmission method in parallel with the first radio transmission method, wherein the second radio transmission method can use radio transmission resources of the duplex gap.

In such a scenario, it must be ensured that in a radio transmission with radio transmission resources which can be allocated to the duplex gap, existing radio transmissions of the first radio transmission method are not disturbed by the second radio transmission method, or only to a slight extent.

Similarly, it should be ensured that the reception in the second radio transmission method, when using the radio transmission resources of the duplex gap, is not disturbed by the first radio transmission method, or only to a slight extent.

### SUMMARY

In one aspect, a method for reducing interference or for avoiding interference is specified, for radio communication systems which are operated in parallel next to one another as described initially. In particular, the method can be used if the common frequency band considered is only managed and used by one network operator.

In particular, the method can be used if this one network operator uses both radio communication systems or both radio transmission methods, respectively, next to one another at in each case identical sites.

In the USA, for example, respective frequency bands are auctioned or sold to network operators so that a network operator can here meet the aforementioned prerequisites. The so-called “UMTS extension band”, too, will probably be correspondingly issued globally.

The method, by using so-called a priori knowledge, enables interference to be avoided in a spatial area or in a radio cell considered, with little expenditure of additional technical facilities.

In particular, the method can be used if the first and/or the second radio transmission method use subcarriers for the radio transmission or as radio transmission resources.

The above-described embodiments of the present invention are intended as examples, and all embodiments of the present invention are not limited to including the features described above.

### BRIEF DESCRIPTION OF THE DRAWINGS

In the text which follows, the invention will be explained in greater detail with reference to a drawing, in which:

FIG. 1 shows the method according to an embodiment of the invention by means of an FDD radio transmission and a TDD or FDD radio transmission occurring in parallel thereto,

FIG. 2 shows a first power control, based on the a priori knowledge of the method according to an embodiment of the invention, for reducing interference,

FIG. 3 shows a second power control, based on the a priori knowledge of the method according to an embodiment of the invention, for reducing interference, and

FIG. 4 shows a consideration of the method according to an embodiment of the invention with the assumption of a constant carrier-to-interference ratio, called C/I ratio.

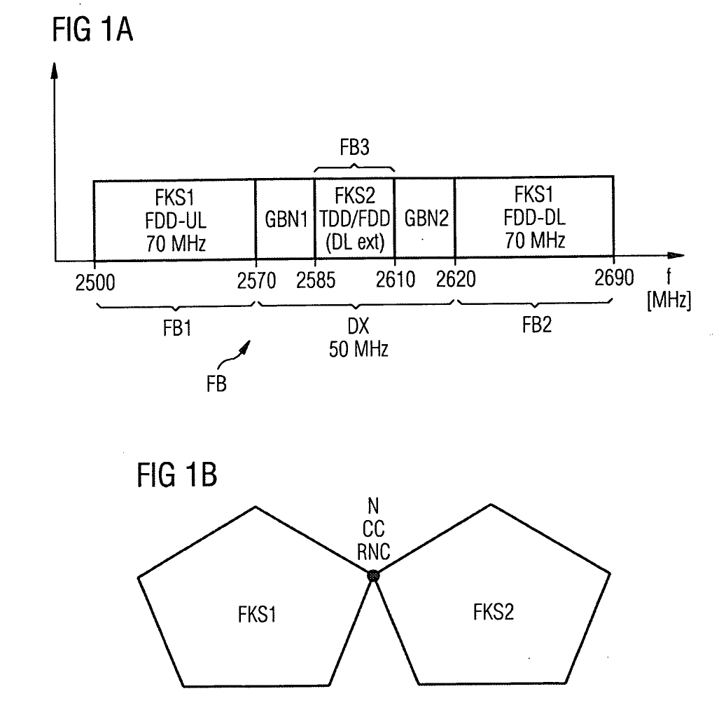

FIG. 1A shows the method according to an embodiment of the invention by means of an FDD radio transmission and a TDD or FDD radio transmission occurring in parallel thereto.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

The FDD radio transmission is used, for example, in a 3GPP LTE OFDMA radio communication system, the abbreviation “3GPP” standing for “3rd Generation Partnership Project” whilst the abbreviation “LTE” means “Long Term Evolution”.

The abbreviation OFDMA, with “Orthogonal Frequency Division Multiple Access”, describes a radio transmission method in which a multiplicity of subcarriers modulated simultaneously is used for the radio transmission.

In the text which follows, this FDD radio transmission is considered as radio transmission method of a first radio communication system FKS1.

In parallel with the first radio transmission, a TDD radio transmission or a further FDD radio transmission of a WiMax radio communication system is to be carried out. This parallel radio transmission is considered as radio transmission method of a second radio communication system FKS2 in the text which follows.

Along the horizontal axis shown, frequencies of a frequency band FB are plotted in MHz.

A first frequency range FB1 with a width of 70 MHz extends from 2500 MHz to 2570 MHz, a second frequency range FB2 with a width of 70 MHz extends from 2620 MHz to 2690 MHz.

Associated radio transmission resources of the first frequency range FB1 and of the second frequency range FB2 are used for radio transmission by the first radio communication system FKS1.

In this context, the first frequency range FB1 is used for an FDD radio transmission FDD in the uplink direction UL whilst the second frequency range FB2 is used for an FDD radio transmission FDD in the downlink direction DL.

To avoid disturbances between the first frequency range FB1 and the second frequency range FB2, a so-called duplex gap DX is provided between the two as a safety gap with a width of 50 MHz which thus extends from 2570 MHz to 2620 MHz.

Associated radio transmission resources of the duplex gap DX can now be used at least partially for a parallel radio transmission by the second radio communication system FKS2.

To continue to guarantee a safety gap, the second radio communication system FKS2 uses only radio transmission resources of a third frequency range FB3 which in this case extends from 2585 MHz to 2610 MHz in order to carry out a TDD radio transmission TDD or an FDD radio transmission FDD, for example in the downlink direction DL ext.

Or the second radio communication system FKS2 uses only radio transmission resources of a third frequency range FB3′, not shown in detail here, which extends from 2585 MHz to 2620 MHz in order to carry out an FDD radio transmission FDD, for example in the downlink direction DL ext. This is the case, in particular, if an FDD radio transmission of the first radio communication system FKS1 is carried out only in the first frequency range FKS1.

Remaining radio transmission resources between the unused frequencies of 2570 MHz to 2585 MHz form a first guard band GBN1 whilst remaining radio transmission resources between the unused frequencies from 2610 MHz to 2620 form a second guard band GBN2.

The respective magnitude of the guard band GBN1 and of the guard band GBN2, respectively, is calculated from so-called system scenarios based on a worst case consideration. In this context, the worst case is determined by the fact that a radio communication system attempts to receive a mobile station at the limit value of sensitivity whilst another radio communication system is transmitting at the same time.

To minimize or to prevent disturbances or interference of the second radio communication system FKS2 with the first radio communication system FKS1, the two radio communication systems FKS1 and FKS2 form by means of a connection or by an exchange of information planning information designated as a priori knowledge in the text which follows for establishing and operating radio links in both radio communication systems FKS1 and FKS2.

This a priori knowledge contains at least the radio transmission resources of the frequency ranges FB1 and FB2, used or occupied for a radio transmission by the first radio communication system FKS1.

In addition, it comprises the radio transmission resources of the third frequency range FB3, required by the second radio communication system FKS2 for establishing and carrying out a connection.

The first radio communication system FKS1 is also additionally informed how a transmitting/receiving cycle of the second radio communication system FKS2 designed as time division duplex (TDD) is adjusted.

Using this a priori knowledge, it is then possible to select and to arrange radio transmission resources in such a manner that overlapping interference between the radio transmissions of the first radio communication system FKS1 and the second radio communication system FKS2 are largely avoided or reduced, respectively.

Apart from the selection and allocation of the radio transmission resources, there is advantageously additionally a control of the transmitting power of the selected radio transmission resources—particularly if respective subcarriers are used for the radio transmission in the first and/or second frequency range FB1, FB2.

By lowering the transmitting power, a decrease in the interference can be achieved in the case of critical pairings of radio transmission resources.

To form the a priori knowledge, both radio communication systems FKS1 and FKS2 are advantageously connected to one another via a common node N or, respectively both radio communication systems FKS1 and FKS2 have a common control unit CC. This is shown in FIG. 1B.

A common network management unit can be designed, for example, similar to a radio network controller “RNC”, known per se, or—in the case of a multistandard-capable base station—can be a component of the common control unit CC.

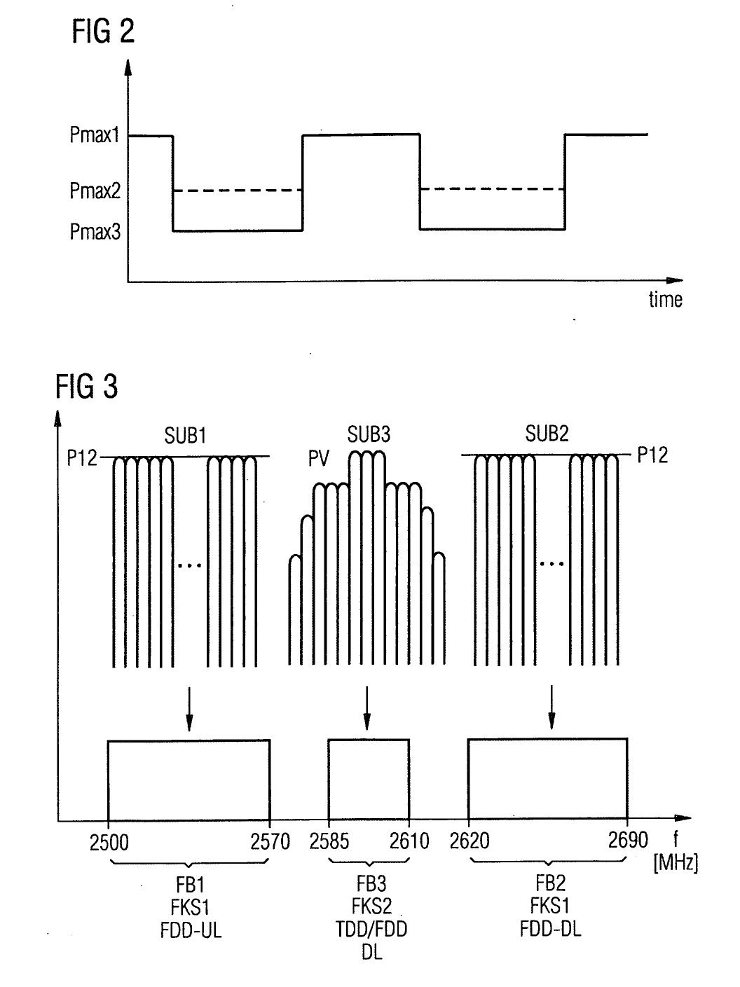

FIG. 2 shows a first power control for reducing interference, based on the a priori knowledge of the method according an embodiment of to the invention.

With respect to FIG. 1, transmitting resources (TX) and receiving resources (RX), which are available to the second radio communication system FKS2 for radio transmission can be allocated unrestrictedly within the third frequency range FB3.

The same applies to the transmitting resources in the second frequency range FB2 of the first radio communication system FKS1 since, due to safety gaps and defined permitted spurious transmissions of the respective transmitters, they allow a coexistent operation without restrictions.

To be able to obtain additional radio transmission resources, for example in the two guard bands GBN1 and GBN2, respectively, resource schedulers of the first radio communication system FKS1 and the second radio communication system FKS2 must have a priori knowledge about the state of the respective other radio communication system for the guard bands GBN1 and GBN2.

In the text which follows, an exemplary procedure for utilizing the radio transmission resources of the guard band GBN2 will be explained in greater detail.

A scheduler of the first (FDD-based) radio communication system has knowledge of the transmitting/receiving cycle of the second (TDD-based) radio communication system.

Disturbances or interference to be avoided occur if the second radio communication system (TDD) attempts to receive while the first radio communication system (FDD) is simultaneously transmitting. For this reason, the first radio communication system (FDD) can also transmit unrestrictedly in times (plotted along the horizontal axis) in which the second radio communication system (TDD) is transmitting. This is shown in FIG. 2 by a transmitting power PMax1 (plotted along the vertical axis).

Hitherto, the FDD transmitter transmitted unrestrictedly even during a receiving cycle of the second radio communication system (TDD) which required a “wide” guard band GBN2. This ensured that spurious emissions of the FDD transmitter decay to a degree which does not impair the reception of a TDD signal at a threshold of sensitivity.

In the case of TDD and FDD transmission occurring simultaneously, this does not present a problem which is why during this cycle, transmitting resources which are located within the guard band GBN2 can also be used for the TDD radio transmission.

Receiving resources for a TDD radio transmission can be used within the guard band GBN2 when the transmitting power of the FDD radio transmission does not exceed a transmitting power value Pmax3. This ensures that weak signals can also be received within the TDD receiving cycle.

When the two schedulers can exchange information or are arranged as common scheduler unit, a power control of the FDD radio communication system has the knowledge of the extent to which a TDD receiving connection is received with high quality—e.g. when a mobile station is located close to a base station.

In this case, a tolerable FDD transmitting power can be defined to a transmitting power value which is greater than the transmitting power value Pmax3—namely in this case the transmitting power value Pmax2 which lies within the range of values between the transmitting power value Pmax1 and the transmitting power value Pmax3.

This increases the probability for the scheduler unit of the FDD radio communication system of allocating a radio transmission resource since the limiting boundary conditions for the allocation have been extended.

In any case, these restrictions of the FDD transmitting resource allocation only relate to the allocations in the frequency edge region. Furthermore, the use of transmitting power values of between Pmax1 and Pmax2 is dependent on the spacing between the frequencies or subcarriers considered since a system filtering effect is increased with increasing distance and thus the effectiveness of the used transmitting power as disturbance decreases in the receiving case.

In the operating case which relates to the guard band GBN1, the ratio between interferer and “victim” changes. In this case, FDD receiving signals are disturbed by the TDD transmitter in the period of the TDD transmitting cycle. In the conventional embodiment, the guard band GBN1 ensures there is no degradation of the FDD receiving operation due to the TDD transmitting signal at any time.

According to an embodiment of the invention, an allocation of TDD transmitting signals is possible due to information of the TDD transmitting/receiving cycle. In a first step, FDD receiving resources can also be allocated at the band edge in the first frequency range FB1 without restrictions. Furthermore, the TDD radio communication system can allocate TDD receiving resources in the guard band GBN1 since there is no interference situation in the receiving state of the FDD radio communication system and of the TDD radio communication system.

In the TDD transmitting state, the TDD transmitting scheduler must limit the transmitting power in the guard band GBN1 to such an extent (Pmax1) that the reception of the FDD receiving signals is not impaired in the first frequency range FB1.

This is also explained in greater detail in FIG. 3 in the text which follows.

Thus, restrictions are imposed on the allocation of TDD transmitting resources, i.e. that the allocation can only be used for those TDD mobile stations which carry out robust services and/or which are located close to the base station.

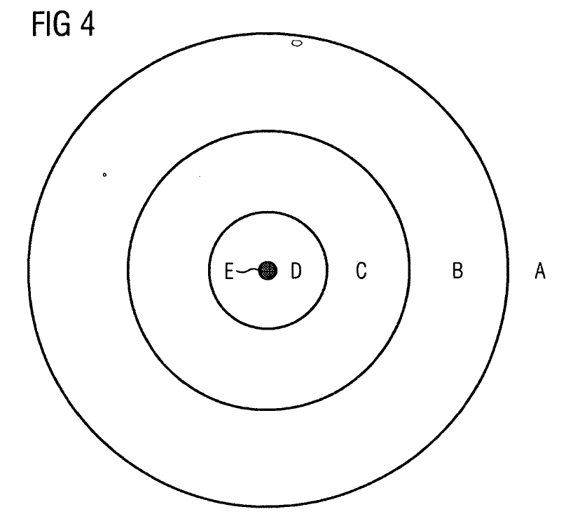

If the schedulers can exchange information going beyond the transmitting/receiving cycle or are arranged jointly as one scheduler, the TDD transmitting power can be matched to the FDD receiving conditions. This is also shown in FIG. 4 described in the text which follows.

FIG. 3 shows a second power control based on the a priori knowledge of the method according an embodiment of to the invention for reducing interference with reference to FIG. 1.

Subcarriers SUB1 and SUB2, respectively, used in the frequency ranges FB1 and FB2 are transmitted with a uniform transmitting power P12 while subcarriers SUB3 used in the frequency range FB3 are transmitted with a nonuniform transmitting power PV in order to minimize interference in the two frequency ranges FB1 and FB2.

FIG. 4 shows a consideration of the method according an embodiment of to the invention, assuming a constant carrier-to-interference ratio, called C/I ratio.

Regions A to D shown are arranged around a base station located at the location E.

Mobile FDD devices which are located close to the base station can “tolerate” more interference power, seen from the TDD radio communication system.

In this case, the TDD transmitting power can be correspondingly adapted, assuming that the two schedulers have a common knowledge about the channel quality.

In addition, the interfering effect of the TDD transmitting power which must be taken into consideration in the FDD receiving case, is known a priori due to an a priori initiation of correspondingly increased transmitting powers at respective mobile stations. This ensures an adequate receiving quality even in this interference situation.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A method for reducing interference between two radio communication systems, comprising:
accessing radio transmission resources of a common frequency band for carrying out a radio transmission at a first radio communication system and a second radio communication system,
separating a first frequency range and a second frequency range by a duplex gap,
using allocated radio transmission resources of the first frequency range and of the second frequency range at the first radio communication system,
forming a part of the duplex gap with a third frequency range,
using allocated radio transmission resources of the third frequency range at the second radio communication system,
exchanging information for forming a priori knowledge about a connection at a network end at the first radio communication system and the second radio communication system,
comprising the a priori knowledge of at least the radio transmission resources of the first frequency range and of the second frequency range provided by the first radio communication system and the radio transmission resources of the third frequency range required for establishing and carrying out a connection,
selecting radio transmission resources in dependence on the a priori knowledge for reducing interference between the first radio communication system and the second radio communication system, at least at the second radio communication system, and
transmitting subcarriers used in the third frequency range with a nonuniform transmitting power.

14. The method as claimed in claim 13, further comprising selecting the radio transmission resources in dependence on the a priori knowledge for reducing interference additionally at the first radio communication system.

15. The method as claimed in claim 13, further comprising controlling the transmitting power of the allocated radio transmission resources in dependence on the a priori knowledge.

16. The method as claimed claim 13, further comprising exchanging information via a common node or via a common network management unit in order to form the a priori knowledge at the first radio communication system and the second radio communication system.

17. The method as claimed in claim 13, further comprising using an OFDMA radio communication system as the first radio communication system or as the second radio communication system.

18. The method as claimed in claim 16, further comprising using a radio network controller “RNC” as common network management unit.

19. The method as claimed in claim 16, further comprising using a central control unit within a multistandard base station as the common network management unit.

20. The method as claimed claim 13, further comprising:
using a radio communication system with an FDD radio transmission as the first radio communication system, or
using a radio communication system with a TDD radio transmission as the second radio communication system.

21. The method as claimed in claim 20,
using a 3GPP LTE radio communication system as the first radio communication system, or
using a WiMax radio communication system as the second radio communication system.

22. The method as claimed in claim 13, further comprising:
using the first frequency range for an FDD radio transmission in the uplink direction; and
using the second frequency range for an FDD radio transmission in the downlink direction.

23. The method as claimed in claim 13, further comprising using the third frequency range for an FDD radio transmission or for a TDD radio transmission in the downlink direction.

24. The method as claimed in claim 13, further comprising using remaining radio transmission resources between the first frequency range and the third frequency range or between the second frequency range and the third frequency range as a guard band.

25. The method as claimed in claim 14, further comprising controlling the transmitting power of the allocated radio transmission resources in dependence on the a priori knowledge.

26. The method as claimed claim 25, further comprising exchanging information via a common node or via a common network management unit in order to form the a priori knowledge at the first radio communication system and the second radio communication system.

27. The method as claimed in claim 26, further comprising using an OFDMA radio communication system as the first radio communication system or as the second radio communication system.

28. The method as claimed in claim 27, further comprising using a radio network controller “RNC” as common network management unit.

29. The method as claimed in claim 27, further comprising using a central control unit within a multistandard base station as the common network management unit.

30. The method as claimed claim 28, further comprising:
using a radio communication system with an FDD radio transmission as the first radio communication system, or
using a radio communication system with a TDD radio transmission as the second radio communication system.

31. The method as claimed in claim 30,
using a 3GPP LTE radio communication system as the first radio communication system, or
using a WiMax radio communication system as the second radio communication system.

32. The method as claimed in claim 31, further comprising:
using the first frequency range for an FDD radio transmission in the uplink direction; and
using the second frequency range for an FDD radio transmission in the downlink direction.

33. The method as claimed in claim 32, further comprising using the third frequency range for an FDD radio transmission or for a TDD radio transmission in the downlink direction.

34. The method as claimed in claim 33, further comprising using remaining radio transmission resources between the first frequency range and the third frequency range or between the second frequency range and the third frequency range as a guard band.

35. The method as claimed claim 29, further comprising:
using a radio communication system with an FDD radio transmission as the first radio communication system, or
using a radio communication system with a TDD radio transmission as the second radio communication system.

36. The method as claimed in claim 35,
using a 3GPP LTE radio communication system as the first radio communication system, or
using a WiMax radio communication system as the second radio communication system.

37. The method as claimed in claim 36, further comprising:
using the first frequency range for an FDD radio transmission in the uplink direction; and
using the second frequency range for an FDD radio transmission in the downlink direction.

38. The method as claimed in claim 37, further comprising using the third frequency range for an FDD radio transmission or for a TDD radio transmission in the downlink direction.

39. The method as claimed in claim 38, further comprising using remaining radio transmission resources between the first frequency range and the third frequency range or between the second frequency range and the third frequency range as a guard band.
